(19) United States
(12) Patent Application Publication
(10) Pub. No.: US 2025/0341414 A1
(43) Pub. Date: Nov. 6, 2025

(54) MAGNETOSTRICTIVE FUEL TANK VOLUME GAUGING SYSTEM FOR PORTABLE TANKS

(71) Applicant: Travis Leach, Halliday, ND (US)

(72) Inventor: Travis Leach, Halliday, ND (US)

(21) Appl. No.: 18/656,532

(22) Filed: May 6, 2024

(51) Int. Cl. G01F 23/68

(52) U.S. Cl. CPC G01F 23/68

(57) ABSTRACT

A fuel tank volume gauging system comprising two or more elongated sleeves detachably insertable into through a flange into a fuel tank, the elongated sleeves comprising an interiorly-housed shaft spaced away from the sleeve upon which a float travels.

### FIELD OF THE INVENTION

This invention relates to fuel tank volume meters, and more particularly relates to a fuel tank sensor adapted to measure volume using floats integrated within hollow tubing.

### BACKGROUND

### Description of the Related Art

The present invention constitutes an improvement to standard fuel tank volume meters. Typically, a volume of petroleum, water, or other liquid is measured using a fuel sensor internal to the fuel tank, often comprising a simply float affixed to an articulating lever arm working in connection with a potentiometer.

While this system is simple and cost-effective, it has many drawbacks, including the lever becoming bent or deformed, and limited mobility of the lever between upper and lower thresholds. Additional drawbacks include the float bouncing during transit with waves and changing fuel levels and an inability to digitally measure and report fuel levels across the length of a tank when the tank is not level. Traditional levers and potentiometer are notoriously inaccurate, leading to approximation of fuel content and providing opportunities for unscrupulous actors to overfill and underfill tanks without accountability on pickup sites.

It is therefore an object of the present invention to provide a more accurate, reliable tank level sensor which does fluctuate with bouncing roads, unlevel surfaces, nor suffer from the inaccuracies of traditional meter and methods of estimating fuel volume, and which can measure and average different fuel levels across different ends of a tank, including an elongated tank in tow behind a semitruck. There is a need to provide increased fuel volume metering accuracy and a volume meter adapted and operable to overcome these deficiencies in the art.

### SUMMARY

From the foregoing discussion, it should be apparent that a need exists for a tank volume gauging system for portable tanks which overcomes inefficiencies with the prior art.

The present invention has been developed in response to the present state of the art, and in particular, in response to the problems and needs in the art that have not yet been fully solved by currently available apparti and implements.

Accordingly, the present invention has been developed to provide a fuel tank volume gauging system comprising: two or more hollow cylindrical sleeves, each sleeve defining a plurality of slits toward an upper proximal end; a flange affixed to an upper surface of a tank operable to hold a liquid, the flange comprising a downwardly protruding cylindrical protuberance affixed to a cylindrical sleeve, wherein the flange defines a hollow interior through passage into which an elongated shaft is inserted; two or more elongated cylindrical shafts, each shaft housed within a sleeve and spaced away from contract with the sleeve; an annular float housed within the sleeve and traveling vertically on a shaft.

The liquid may comprise petroleum. The fuel tank volume gauging system may further comprise a cylindrical bracket affixed to a distal end of the sleeve. The fuel tank volume gauging system may further comprise, in some embodiments, an attachment bracket welded to the bottom of a tank.

A second fuel tank volume gauging system is provided comprising: two or more hollow cylindrical sleeves, each sleeve defining a plurality of slits toward an upper proximal end; a flange affixed to an upper surface of a tank operable to hold a liquid, the flange comprising a downwardly protruding cylindrical protuberance affixed to a cylindrical sleeve, wherein the flange defines a hollow interior through passage into which an elongated shaft is inserted; two or more elongated cylindrical shafts, each shaft housed within a sleeve and spaced away from contract with the sleeve; an annular float housed within the sleeve and traveling vertically on a shaft; a cylindrical bracket affixed to a distal end of the sleeve; and an attachment bracket welded to the bottom of a tank.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention may be practiced without one or more of the specific features or advantages of a particular embodiment. In other instances, additional features and advantages may be recognized in certain embodiments that may not be present in all embodiments of the invention.

These features and advantages of the present invention will become more fully apparent from the following description and appended claims, or may be learned by the practice of the invention as set forth hereinafter.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is a frontal, side perspective view of a fuel tank volume gauging apparatus in accordance with the present invention;

FIG. 2A is a sectioned, front perspective view of a fuel tank volume gauging apparatus in accordance with the present invention;

FIG. 2B is a sectioned, front perspective view of a fuel tank volume gauging apparatus in accordance with the present invention;

FIG. 2C is a sectioned, front perspective view of a fuel tank volume gauging apparatus in accordance with the present invention;

FIG. 2D is a sectioned, front perspective view of a float of a fuel tank volume gauging apparatus in accordance with the present invention;

FIG. 3A is a side perspective view of a flange of a fuel tank volume gauging apparatus in accordance with the present invention;

FIG. 3B is a side perspective view of a flange of a fuel tank volume gauging apparatus in accordance with the present invention;

FIG. 3C is a top perspective view of a flange of a fuel tank volume gauging apparatus in accordance with the present invention;

FIG. 3D is a top perspective view of a flange of a fuel tank volume gauging apparatus in accordance with the present invention;

FIG. 4A is a top perspective view of a flange cap of a fuel tank volume gauging apparatus in accordance with the present invention;

FIG. 4B is a top perspective view of a flange cap of a fuel tank volume gauging apparatus in accordance with the present invention;

FIG. 5 is a front perspective view of a computer interface of a fuel tank volume gauging apparatus in accordance with the present invention;

FIG. 6 is a front perspective view of a transceiver of a fuel tank volume gauging apparatus in accordance with the present invention;

FIG. 7 is a front perspective view of a cylindrical bracket attachment of a fuel tank volume gauging apparatus in accordance with the present invention;

FIG. 8 is an environmental perspective view of a fuel tank volume gauging apparatus in accordance with the present invention;

FIG. 9 is a front perspective view of a tank attachment bracket of a fuel tank volume gauging apparatus in accordance with the present invention;

FIG. 10 is an environmental perspective view of a fuel tank volume gauging apparatus in accordance with the present invention; and

FIG. 11 is an environmental perspective view of a fuel tank volume gauging apparatus in accordance with the present invention.

### DETAILED DESCRIPTION

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Furthermore, the described features, structures, or characteristics of the invention may be combined in any suitable manner in one or more embodiments. In the following description, numerous specific details are provided to provide a thorough understanding of embodiments of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

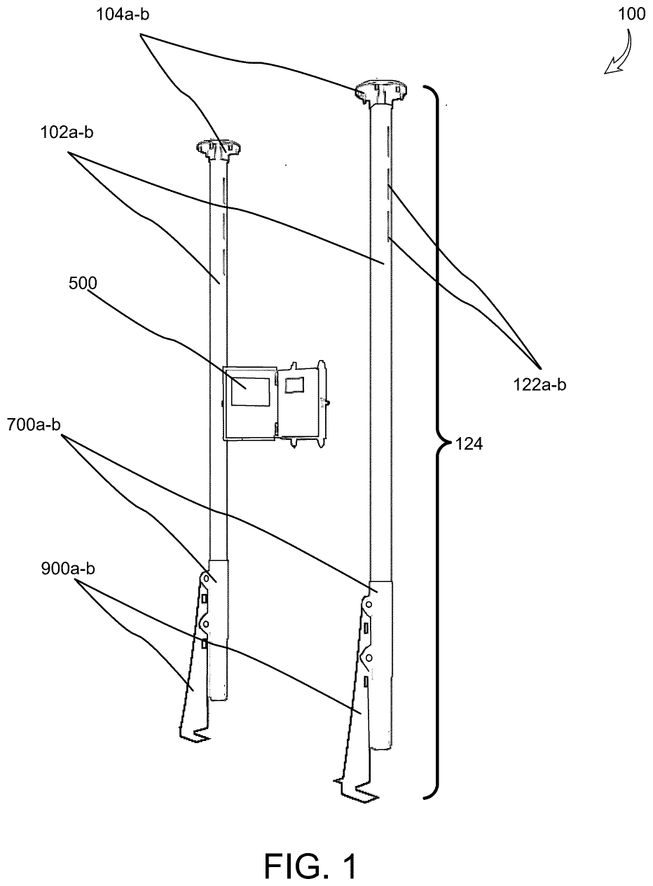

FIG. 1 is a frontal, side perspective view of a fuel tank volume gauging apparatus 100 in accordance with the present invention.

In the shown embodiment, the apparatus comprises two volume sensors 124. Each volume sensor 124 comprises an elongated sleeve 102 defining one or more slits 122. The slits 122 may be arranged in parallel toward a top of the elongated sleeve 102 (i.e., a proximal end of the elongated sleeve 102).

The elongated sleeve 124 may be fabricated from polymeric or metal alloy materials. The elongated sleeve 124 comprises a cylindrical body and defines a hollow interior recess 206 within which a float 202 travels.

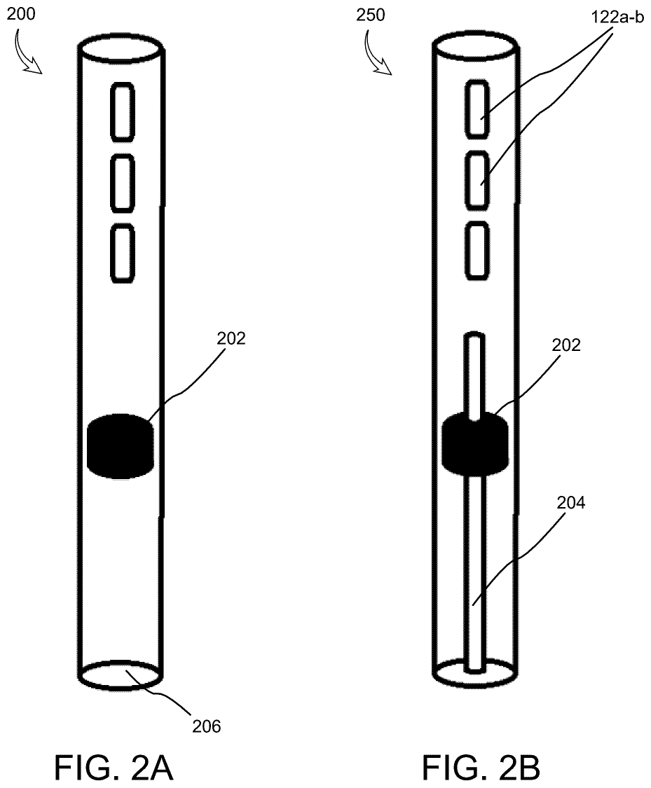

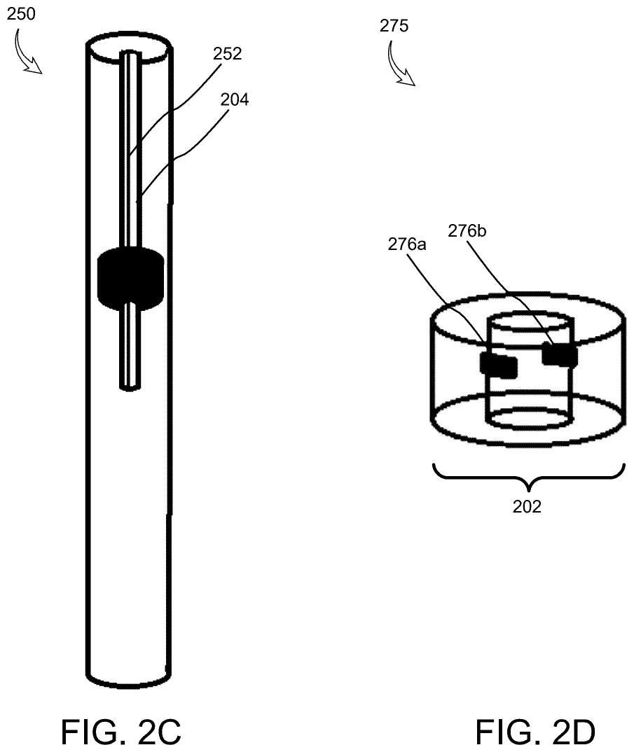

FIGS. 2A-2D illustrate sectioned, front perspective views of a fuel tank volume gauging apparatus 200, 250 in accordance with the present invention.

In various embodiments, the float 202 comprises a puck or cylindrical component adapted and operable to travel within the elongated sleeve 102. The float 202 may be hollow or fabricated from lighter than petroleum and/or lighter than water components.

In some embodiments, the float 202 defines a bore centrically disposed and traversing the height of the float 202. In some embodiments, the float 202 travels up and down on an axis, or shaft 204, centrally disposed within the hollow interior recess 206.

Although in some embodiments, the shaft 206 may be affixed to the cylindrical bracket 700 and protrude superiorly into the recess 206, in the preferred embodiment the shaft 204 descends inferiorly into the recess 206.

The shaft 206 is electrified with an electric current distributed from wires 808 running into the tank 800. By measuring the electrical resistance on the shaft 206 created by the vertical position of the float 202, the position of the float 202 on the shaft 206 may determined and the level of fluid 1104 within the tank 800 may be determined.

The slits 122a-b may be operable to allow fluid from the tank 800 to flow in and out of the recess 206, but are primarily functional to allow flow of ambient air above the high level of the fluid in the tank 800 into the recess 206 to maintain equilibrium between the pressure in the sensor 102 and the tank 800.

Apparatus 250 comprises a magnetostrictive level sensor that uses a float 202.

In various embodiments, the shaft 204 (i.e., probe 204), comprises a magnetostrictive wire 252 contained in, circumscribing, or running exteriorly to the shaft 204.

The float 202 may comprise a plurality of magnets 276a-b operable to disrupt a magnetic or electric field created by current running through the magnetostrictive wire 252.

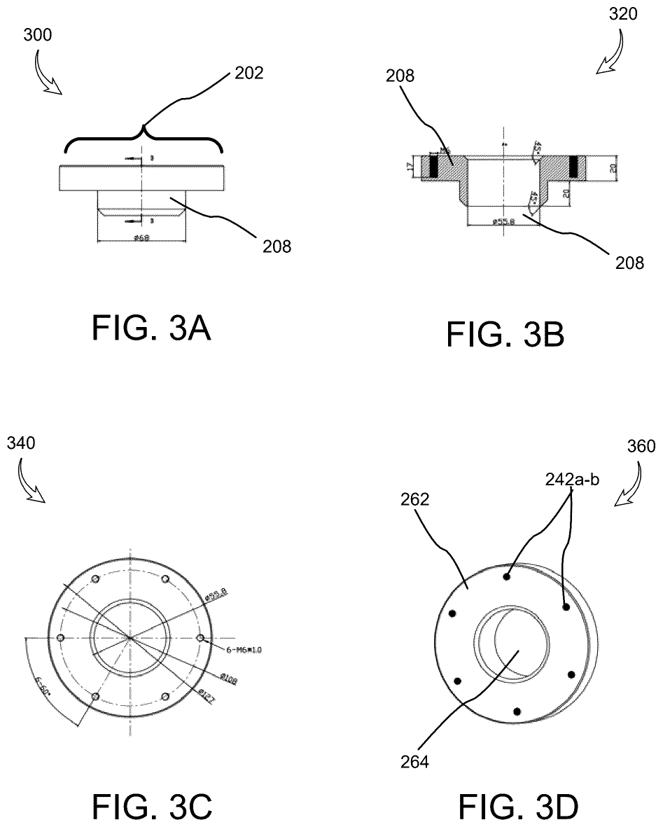

FIGS. 3A-3D is a side perspective view of a flange 300 of a fuel tank volume gauging apparatus in accordance with the present invention.

In various embodiments, a circular aperture is drilled into the top of the tank 800 and an annular flange 300 is inserted thereto. The flange 300 comprises a cylindrical protuberance 208 descending from the flange 300. The cylindrical protuberance 208 affixes to the proximal end of the elongated sleeve 102. In various embodiments, the cylindrical protuberance 208 is threaded, either interiorly, exteriorly or both. The cylindrical protuberance 208 may insert into an open top of the of the sleeve 102.

The flange 300 defines a hollow interior through channel 264 in which the shaft 206 is inserted.

The flange 300 may define a plurality of bores 242 in a skirt 262 circumscribing the aperture drilled into the tank 800. These bores 242 may be used to bolt the flange 300 to the tank 800.

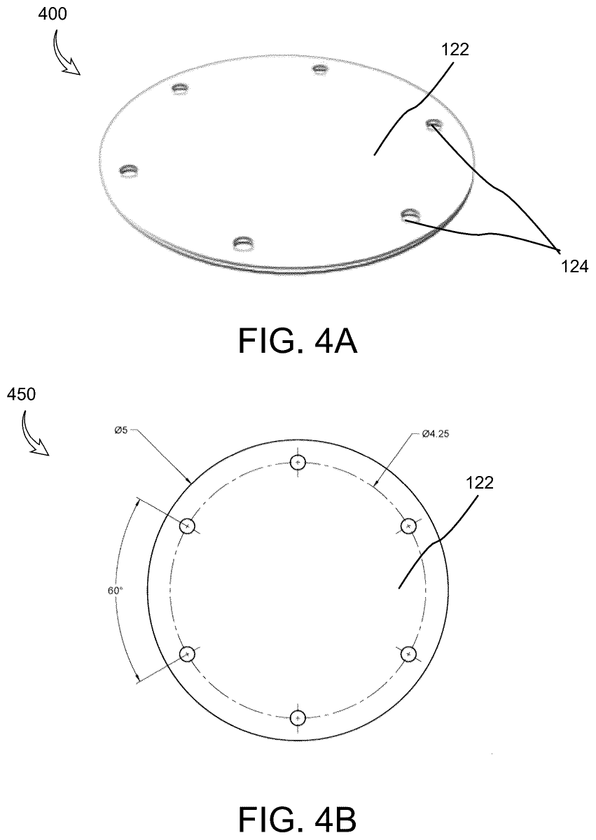

FIGS. 4A-4B illustrate perspective views of a flange cap 400, 450 of a fuel tank 800 volume gauging apparatus in accordance with the present invention.

The flange cap 400, 450 bolts to the top of the flange 300 after the flange 300 has been inserted into the tank 800.

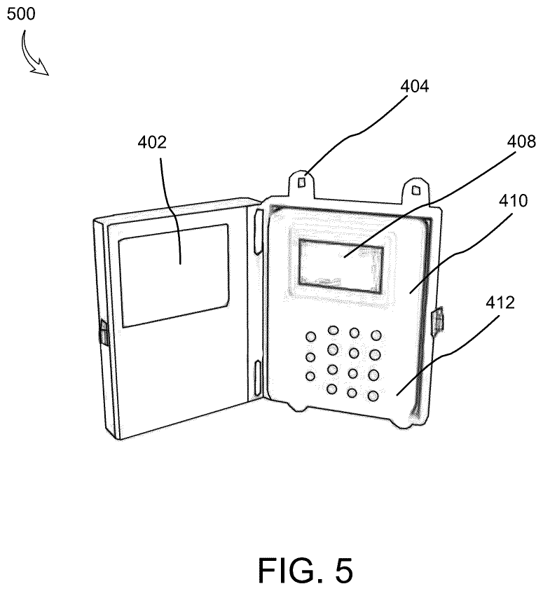

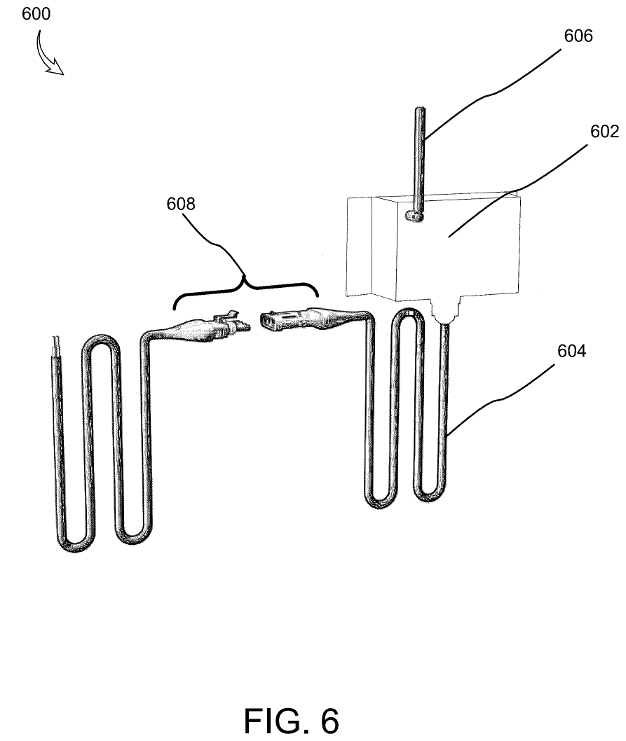

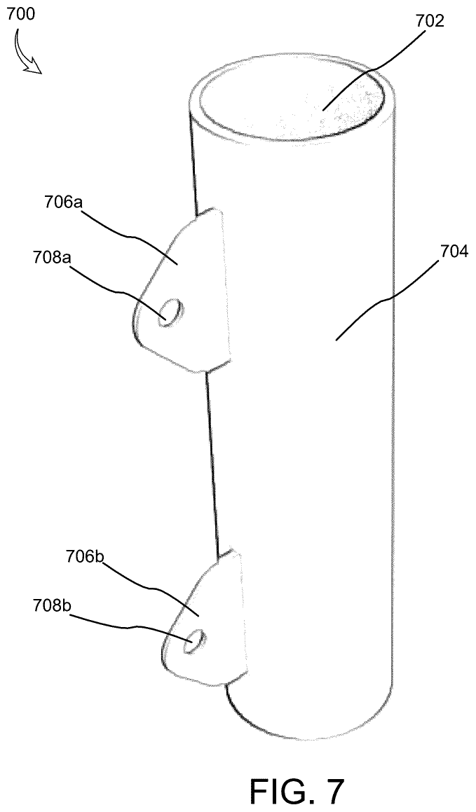

FIG. 5 is a front perspective view of a computer interface 500 of a fuel tank volume gauging apparatus in accordance with the present invention.

The computer interface 500 displays the volume of the tank 800 to an operator, and may display an average of readings across plurality of sensors 124. In various embodiments, the computer interface 500 may be in wireless connectivity with the sensors 124 via a Bluetooth.

The computer interface 500 may comprise a DPD (data processing device) such as a wireless phone with means for relaying and receiving electrical signals enabling device-to-device communication (meaning wireless communication between the transceiver 600 and the computer interface 500). The computer interface 500 may be configured to make use of the Bluetooth® protocols and procedures enabling device-to-device intercommunication connectivity. This functionality may be provided by incorporating the Bluetooth Intercom Profile® and/or the Bluetooth Telephony Profile®, or other wireless technologies known to those of skill in the art.

FIG. 6 is a front perspective view of a transceiver 600 of a fuel tank volume gauging apparatus in accordance with the present invention.

The transceiver 600 comprises a housing 504, an antenna 606, wire 604 and a detachable connection point 608. In various embodiments, the transceiver 600 may comprise a power supply.

FIG. 7 is a front perspective view of a cylindrical bracket 700 attachment of a fuel tank volume gauging apparatus in accordance with the present invention.

The cylindrical bracket 700 comprises a hollow cylindrical body 704 defining a hollow interior recess 702. Two mounting bracket 706 affix laterally to the cylindrical body 704. These mounting brackets 706a-b define one or more apertures 708 adapted to detachably affix the cylindrical bracket 700 to a tank attachment bracket 900.

In some embodiments, the cylindrical bracket 700 comprises an open bottom end for allowing ambient fluid to flow in the tank and to fill the recess 206 and float the float 202.

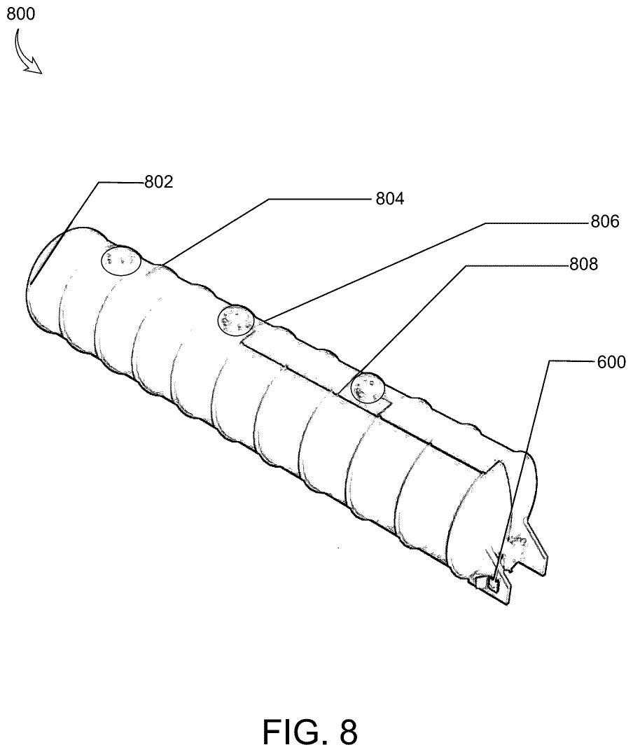

FIG. 8 is an environmental perspective view of a fuel tank volume gauging apparatus in accordance with the present invention.

The Bluetooth receiver is indicated at 802, while the rib of the tank 800 is indicated at 804. Access points on the tank 800 are indicated at 808.

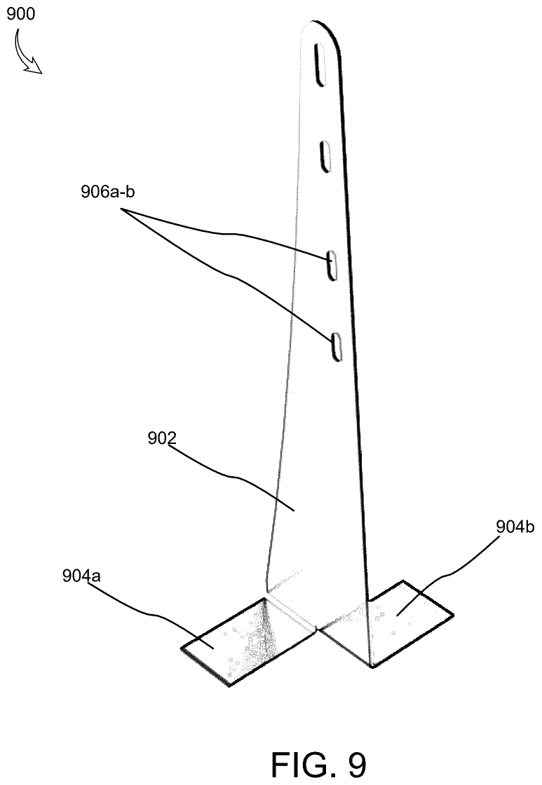

FIG. 9 is a front perspective view of a tank attachment bracket 900 of a fuel tank volume gauging apparatus in accordance with the present invention.

The attachment bracket 900 comprises two tabs 904a-b adapted to be welded or adhered to the bottom of a fuel tank 800. The attachment bracket 900 comprises an upwardly-rising body 902 which defines a plurality of bores 906 adapted to be detached to a cylindrical bracket 700.

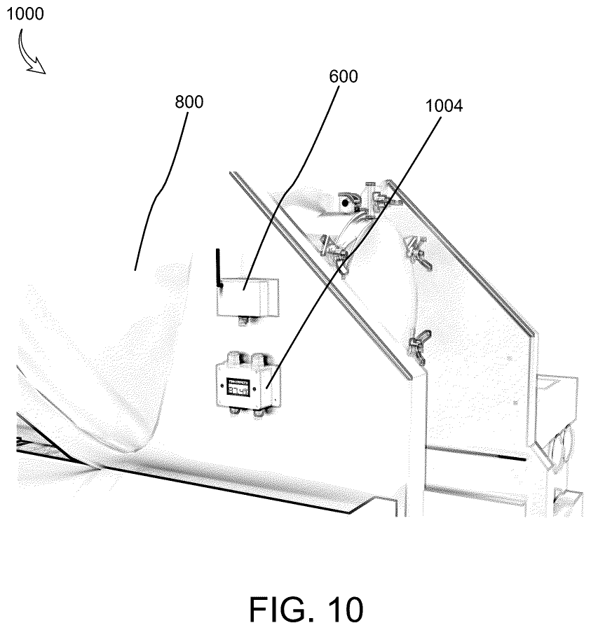

FIG. 10 is an environmental perspective view of a fuel tank volume gauging apparatus in accordance with the present invention.

The apparatus 1000 may comprise a GUI 1004 adapted to show the volume of the tank 800 indicated as a percentage.

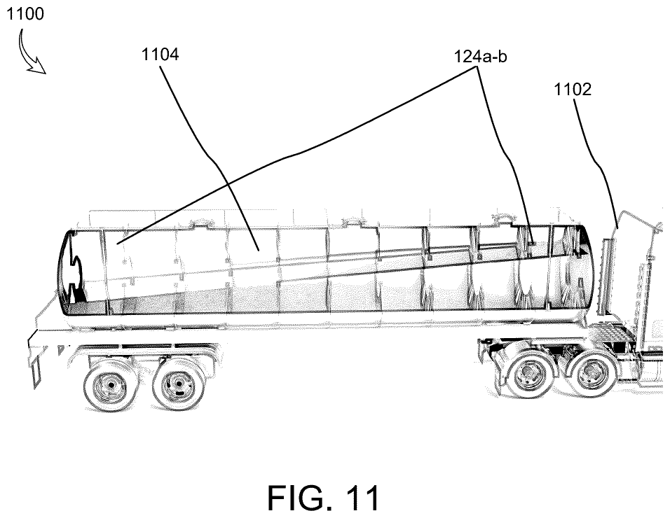

FIG. 11 is an environmental perspective view of a fuel tank volume gauging apparatus 1100 in accordance with the present invention.

Fluid 1104 is housed within the tank 800 affixed to a semitruck 1102. Two sensors 124 position at opposite ends of the tank 800 adapted to measure the depth of fluid 1104 within the tank 800 when the tank 800 is on an unlevel surface.

1. A tank volume gauging system comprising:
two or more hollow cylindrical sleeves, each sleeve defining a plurality of slits toward an upper proximal end;
a flange affixed to an upper surface of a tank operable to hold a liquid, the flange comprising a downwardly protruding cylindrical protuberance affixed to a cylindrical sleeve, wherein the flange defines a hollow interior through passage into which an elongated shaft is inserted;
two or more elongated cylindrical shafts, each shaft housed within a sleeve and spaced away from contract with the sleeve, each elongated cylindrical shaft comprising one or more magnetostrictive wires;
an annular float housed within the sleeve and traveling vertically on a shaft, the annular float comprising one or more magnets.

2. The tank volume gauging system of claim 1, wherein the liquid comprises petroleum.

3. The tank volume gauging system of claim 1, further comprising a cylindrical bracket affixed to a distal end of the sleeve.

4. The tank volume gauging system of claim 1, further comprising an attachment bracket welded to the bottom of a tank, the attachment bracket affixed to a cylindrical sleeve.

5. A tank volume gauging system comprising:
two or more hollow cylindrical sleeves, each sleeve defining a plurality of slits toward an upper proximal end;
a flange affixed to an upper surface of a tank operable to hold a liquid, the flange comprising a downwardly protruding cylindrical protuberance affixed to a cylindrical sleeve, wherein the flange defines a hollow interior through passage into which an elongated shaft is inserted;
two or more elongated cylindrical shafts, each shaft housed within a sleeve and spaced away from contract with the sleeve;
an annular float housed within the sleeve and traveling vertically on a shaft, the annular float comprising one or more magnets;
a cylindrical bracket affixed to a distal end of the sleeve; and
an attachment bracket welded to the bottom of a tank.
